(19) United States
(12) Patent Application Publication
(10) Pub. No.: US 2022/0398940 A1
(43) Pub. Date: Dec. 15, 2022

(54) Non-Visual Virtual-Reality System for Navigation Training and Assessment

(71) Applicants: Lora T. Likova, Greenbrae, CA (US); Christopher W. Tyler, San Francisco, CA (US); Zlatko K. Minev, New York, NY (US)

(72) Inventors: Lora T. Likova, Greenbrae, CA (US); Christopher W. Tyler, San Francisco, CA (US); Zlatko K. Minev, New York, NY (US)

(21) Appl. No.: 17/835,378

(22) Filed: Jun. 8, 2022

Related U.S. Application Data
(60) Provisional application No. 63/208,704, filed on Jun. 9, 2021.

(51) Int. Cl. G09B 21/00; G06F 3/01; G06F 3/16; G06F 3/0346; G01C 21/20; A61H 3/06

(52) U.S. Cl. CPC G09B 21/003; G06F 3/016; G06F 3/167; G06F 3/0346; G09B 21/006; G01C 21/206; A61H 3/061; A61H 2201/5064; A61H 2201/5048; A61H 2003/063

(57) ABSTRACT

A navigation system for a blind individual to guide the individual through a virtual environment, includes a transponder adapted to be carried by the individual, a tracking system for determining the position of said transponder within the virtual environment, and a feedback system coupled to said transponder to generate a non-visual sensory signal indicative of said position of said transponder. The transponder has a primary sensor direction that is aimed by the individual, and the non-visual sensory signal provides indications of virtual objects aligned with said primary sensor direction, whereby the individual may be guided to find or avoid virtual objects in said virtual environment.

### CROSS-REFERENCE TO RELATED APPLICATIONS

This application claims the priority date benefit of U.S. Provisional Application 63/208,704, filed Jun. 9, 2021.

### FEDERALLY SPONSORED RESEARCH

Not applicable.

### SEQUENCE LISTING, ETC ON CD

Not applicable.

### BACKGROUND OF THE INVENTION

### Field of the Invention

The invention is in the field of devices for training and assessing navigation performance without the use of sight, through auditory or other sensory cues, in blind users or under non-visual conditions in sighted users. To date, full-scale navigational training and assessment in the blind has typically been done in real physical space containing real objects. On the other hand, virtual navigation has usually been done through vision (either full vision, as in the sighted, or residual vision, such as in the visual navigation system of Turano et al., 2001, for training low vision subjects with retinitis pigmentosa).

### Description of Related Art

Chebat, Maidenbaum and Amedi (2015, Navigation Using Sensory Substitution in Real and Virtual Mazes, PloS ONE 10(6): e0126307. Doi:10.1371/journal.pone.0126307) developed a handheld device termed the EyeCane that reads out the distance of real objects, but it requires moving and rearranging physical objects to define the layout of the objects defining the navigational path. It is not, therefore, a virtual navigation system.

Seki & Ito (2003), among others, used acoustic signaling to generate a three-dimensional auditory (acoustic) virtual reality in the form of sound sources defined by auditory signals equivalent to those produced by sound sources located in 3D space relative to the navigator. None of these studies used sound signals encoding the parameter of distance from the navigator in directions defined by the orientation of a hand-held device, or did so in free space to an accuracy greater than provided by the satellite-guided GPS system.

U.S. Pat. No. 8,886,462 (Systems, methods, and software for providing wayfinding orientation and wayfinding data to blind travelers) uses input identifying a starting landmark and ending landmark in a particular selected geographic region, then searches a database for the corresponding narrative wayfinding instructions, and outputs them in the form of text or audio to guide a blind pedestrian from the starting landmark to the ending landmark. Such narrative instructions, however, do not provide any feedback about whether the traveler is on or off the designated trajectory. The instructions could update based on the location of the user defined according to GPS information, which can be grossly inaccurate in city streets and are generally unreliable or unavailable for indoor wayfinding.

US20150212712A1 (Advanced navigation techniques for portable devices) describes a hand-held cane-like wayfinding device that is controlled by a virtual reality system to provide haptic (tactile-kinesthetic and vibratory) feedback about the nature of virtual objects in a virtual environment surrounding the user. While the Description include the concept of coupling the haptic information with realistic virtual auditory information about the cane contacting virtual objects, the claims do not include any mention of auditory signals. This publication provides a comprehensive review of related IP, but none of it provides direct auditory feedback for virtual environments in the form of a coded distance signal. Only the EyeCane of Chebat, Maidenbaum and Amedi (2015) provides an auditory coded distance signal, but that is derived from a real environment, not from a virtual environment based on the local acquisition of the position of the hand-held device.

### BRIEF SUMMARY OF THE INVENTION

The invention generally comprises a navigation system for the blind that uses auditory or other non-visual information, such as vibration, force feedback, etc., to generate a virtual environment in empty real space (hereinafter VEERS) for entirely non-visual navigation. The core concept is that the location of an individual person, or other animal or device, is tracked in real indoor or outdoor space by electronic signals from a virtual reality system. Information about the position and other descriptors, such as orientation, of the virtual object is fed back to the individual by auditory or other non-visual sensory means to allow assessment of their ability to non-visually navigate a space inhabited by objects. An auditory signaling code is used to convey the distance of objects in a virtual space to the user in relation to their current position, for example in order for them to avoid contact with the objects. The direction of the virtual objects is conveyed by the orientation of the hand-held transponder. To be useful to a walking pedestrian, the system has to have an accuracy much greater than is provided by the satellite-guided GPS signals, especially for indoor training applications, where GPS can be highly inaccurate over many meters. The system of the invention readily overcomes this challenge and meets the high accuracy required for a walking pedestrian.

The effectiveness of the navigation system derives from the ability of the user to encode a mental map of the route to be navigated. Armed with this mental map, users can then employ the distance signal from the device to determine their location and orientation in space relative to the features of the map. The system is thus designed to train users in the facility of using such mental map transformations for effective navigation, based on their spatial memory of the layout of the navigable routes in the area that they are navigating.

In a typical embodiment, an auditory signal emitted by a hand-held orientable transponder is arranged to vary in some parameter(s), such as pitch and/or intensity, in proportion to the straight-line distance from the transponder along its line of orientation to the nearest virtual object, with far-to-near distance encoded by low to high pitch, for example. Thus, as long as the distance signal remains low or is absent, the user knows that they are able to proceed in that direction without impediment by a virtual object, but if the pitch increases, it implies that an object is close and that they should search for an open path by reorienting the transponder in different directions. The transponder location and orientation are provided by ultra-wideband (UWB) radio signal technology with base-stations receiving signals from a moving transponder enabling its position and orientation in 3D space to be identified with sufficient accuracy to guide the user at each step.

### Advantageous Effects

The VEERS system is risk-free for indoor navigation because the user is navigating within an empty space populated with only virtual objects.

As no physical objects or partitions need to be built or reconfigured, moved or rearranged, VEERS allows high flexibility for setting up multiple virtual environments, varying their complexity, reconfiguring them for repeated testing, training, etc.

The VEERS system is particularly useful for training both blind and blindfolded sighted individuals in spatial orientation skills, such as planning and following navigation directions from a memorized spatial map, or making further decisions, such as recasting the planned route if an unexpected obstacle is encountered, together with core spatial cognition capabilities such as spatial memory and spatiomotor coordination.

With regard to virtual space, the VEERS system will provide accurate positional and speed readout of the user navigating a virtual layout in an empty space. (Note that the previous work along these lines does not have these benefits; the EyeCane, a handheld device by Chebat, Maidenbaum and Amedi (2015) reads out the distance—up to 5 m of real objects, but it is not able to read out distances to virtual objects, provides no readout of the user's position in space, and requires moving and rearranging physical objects to form the navigational paths being tested.)

With regard to real space, various other aspects can provide other advantages, such as using an optical distance meter in a real physical environment with the same form of distance coding, to provide a blind or visually impaired person with a flexible distance readout in every direction from where they are currently located (according to the direction in which the handheld device is pointing.) This approach can provide effective navigation for regions that are poorly served by smartphone-mediated GPS such as indoor areas, outdoor city areas where the signal is distorted by tall buildings, or regions lacking cellphone service.

### BRIEF DESCRIPTION OF THE DRAWINGS

FIG. 1 depicts a blindfolded user tracking a trajectory through a virtual street layout within an empty indoor space of the VEERS system of the invention.

FIG. 2 is a plan layout showing one embodiment that employs multiple positional anchors and a handheld transponder to establish the virtual empty environment and tracking capabilities.

FIG. 3 is a functional block diagram depicting the operation of the VEERS system of the invention.

FIG. 4 depicts a further embodiment of the VEERS invention in which the individual is tracked by multiple cameras within the virtual layout.

FIG. 5 depicts another embodiment of the VEERS system in which a hand-held real (non-virtual) ranging device provides information about the distances of real objects within the virtual space.

FIG. 6 depicts another embodiment of the VEERS system in which a hand-held real (non-virtual) ranging device provides information about the distances of real objects within the virtual space, using a narrow directional beam to detect objects.

FIG. 7 depicts a further embodiment of the VEERS system in which the direction of movement of the finger on the screen of the device indicates the distance to virtual objects or scene layout features in a miniaturized version of the VEERS concept.

### DETAILED DESCRIPTION OF THE INVENTION

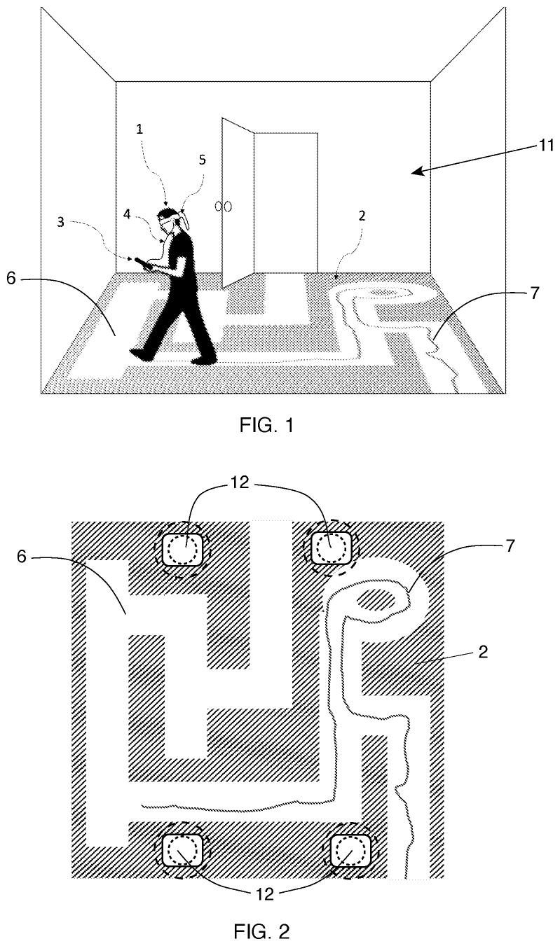

The invention generally comprises a navigation system for the blind that uses auditory or other non-visual information, such as vibration, force feedback, etc., to generate a virtual environment in empty real space (hereinafter VEERS) for entirely non-visual navigation. With regard to FIG. 1, the system provides an empty space 11 that may comprise an indoor room or an outdoor space that includes a floor or surface for an individual 1 to stand and move about without encountering real obstacles. A virtual layout 2 is defined by the system software, and a handheld transponder 3 conveys the information about the virtual layout 2 to the user 1 by an auditory or other signal coding the distance to the nearest obstacle in the direction that the transponder is pointing. Here the auditory signal is conveyed by a cable 4 to an earpiece in the user's ear, although wireless audio devices may alternatively be used. The user 1 might be blind or have their sight occluded by a blindfold 5. The virtual-reality layout defines a desired path 6 for the individual 1 to follow, and the actual path 7 is detected by the system.

With regard to FIG. 2, one embodiment of the VEERS design utilizes a Pozyx UWB (ultra-wide band) wireless positioning system (Pozyx BVBA, Belgium). It includes an advanced modular architecture consisting of a system of at least 4 positional anchors 12, and the handheld transponder 3 is wirelessly connected to the UWB anchors. The anchors 12 provide the signals for tracking the user position in the empty space of the VEERS non-visual tracking system. The transponder operates as an extended virtual cane to provide auditory information about the distance to virtual objects in any direction the user 1 is pointing it in the empty VEERS space. In this way, the real navigational space can be populated by a virtual auditory layout with which to prompt and test the user's ‘cognitive map’ by navigating correctly. The virtual auditory layout can be a continuous arrangement of virtual walls defining navigable streets or other spaces between them, or isolated virtual objects arranged in the navigation space.

With regard to FIG. 4, a further embodiment is the implementation of the VEERS system based on other means of tracking the position and orientation of the transponder. A pair (or more) of optical imaging sensors 21 provide optical imaging of the transponder 3 from above, and tracks the individual 1 as well as the orientation of the transponder 3, so that directional prompting may be provided under software control through the transponder 3. Again, this embodiment populates the real navigational space by a virtual auditory layout with which to test the user's ‘cognitive map’ by navigating correctly along a trajectory 6 conveyed by auditory or other non-visual sensory cues. In a similar way multi-camera optical tracking, or any of the array of optical tracking techniques reviewed in Welch, Bishop, Vichy, Brumback, Keller & Colucci (2001, High-Performance Wide-Area Optical Tracking, may be employed.

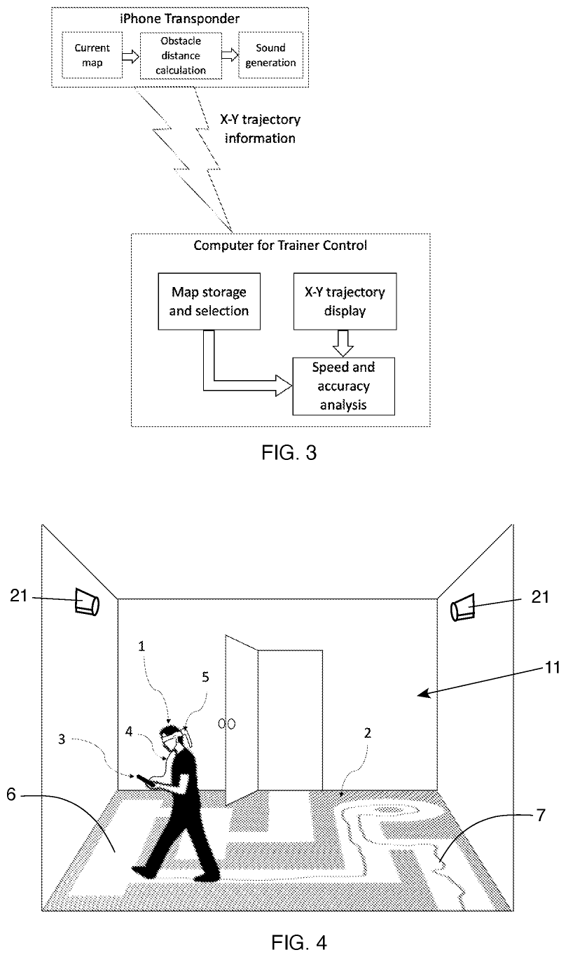

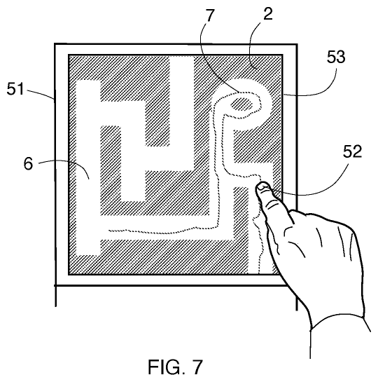

With regard to FIGS. 3 and 7, a further embodiment is the implementation of the VEERS system based on replacing the transponder with a smartphone 51 or other self-tracking device. The smartphone 51 tracks the individual 1 as well as the direction in which the transponder 51 is pointing, so that directional prompting may be provided under software control from within the smartphone 51. Again, in this embodiment the real navigational space is populated by a virtual auditory layout with which to test the user's ‘cognitive map’ by navigating correctly along a trajectory 6 conveyed by auditory or other non-visual sensory cues. The positional and directional information of the directional distance to virtual obstacles provided by the smartphone may be employed in a similar way.

The directional distance signal to the virtual objects can be a pitch of a tone, with a low tone for distant objects, increasing in frequency (and urgency) as the (virtual) object or obstacle is approached. Other forms of obstacle readout could be utilized, or included together with the distance encoding, such as knocking sounds when a wall is encountered. The transponder could indicate the distance of obstacles in the direction of the transponder's orientation by a tactile readout such as the intensity of its vibration, or by an auditory verbal readout of the distance to the object. Auditory parameters such as frequency, amplitude, pulse and rhythms may be used to convey details about the virtual environment, and each parameter may have an established correspondence with a respective physical aspect such as the size and relative motion of the virtual objects. The user scans the virtual transponder beam across the space to obtain wide-angle sense of the arrangements of objects in the virtual scene. (Note that this system does not require recreating the ambient sounds of a real environment, which is the approach taken by prior auditory virtual reality systems, or overlaying the auditory identifiers for specific target location, which is an approach taken by prior augmented reality systems.)

The system may encode the aspects of the structure of the object, such as its height and width, and include that information in the non-visual—auditory, tactile or verbal—readout. A further embodiment of this information could be to encode the size of objects as a second variable such as sound or vibrational intensity, or verbal specification of the width and height of the obstacle.

The basic training function of the invention is to allow the user to build up and verify a mental map of the auditory virtual reality space by navigating through it guided by the auditory distance cue. The accuracy of the mental map can be improved by practice in minimizing the errors and maximizing the speed of navigation through the virtual paths defined in the map. This enhanced capability of deploying mental mapping by blind users, or non-visually in sighted users, can be of general use when navigating real physical environments guided by the usual means of the long cane and general auditory cues. It may be appreciated that the training activities take place in an open space that is generally free of obstacles and obstructions, so that the training routines avoid collisions and impacts with objects and are generally safe.

The training procedure utilizing the VEERS system may include initial training on tactile maps through hand exploration and memorizing of the navigational layout, such as the Likova Cognitive-Kinesthetic Training (see U.S. Pat. No. 10,722,150, issued Jul. 28, 2020), further transferred to the full-scale VEERS navigational layout for extended training and assessment of non-visual navigational capabilities. As the VEERS system can serve both assessment and navigational training, it has the potential to become a useful tool in the O&M instructors' practice.

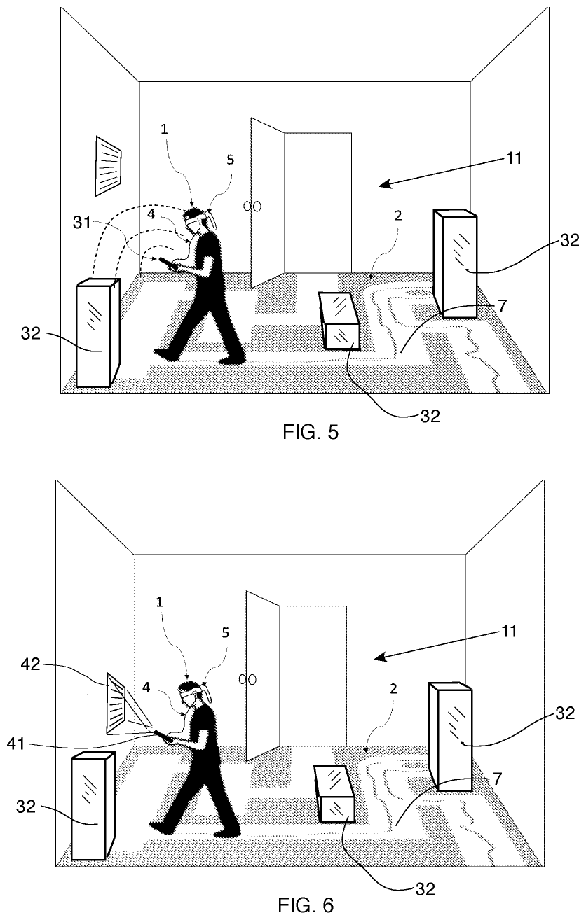

With regard to FIG. 5, a further embodiment of the transponder element of the system is a hand-held real (non-virtual) laser or radar ranging device 31 that radiates a directional signal to detect objects by receiving reflections therefrom. A plurality of real objects 32 may be placed within the layout 2 to act as obstacles or markers within the layout. This system uses the various feedback modes of the VEERS system to provide information about the distances of the objects 32 in the direction of the signal from the laser or radar in the real world, to the user. These feedback modes include audio pitch, audio pulse frequency, tactile vibration frequency or verbal specification of the distance. As in the VEERS system, the user would scan the beam across the physical scene to obtain wide-angle sense of the arrangements of objects in the real scene.

With regard to FIG. 6, another embodiment of the real-world ranging system includes a handheld device 41 in which the laser or radar ranging beam has a vertical spread or rapid vertical scan beam 42, so as to capture distance information about real-world objects with a narrow vertical extent, such as a tree-branch, that might be missed by a point-wise beam. The feedback signal would be processed to specify the nearest part of the objects or walls encountered by the vertical beam, to allow the user to treat them as avoidable obstacles.

With regard to FIG. 7, another embodiment of the invention is a handheld device 51 such as a tablet computer or smartphone to both train and test navigational skills by means of audio-haptic feedback. However, instead of coding position on the screen of the device, as in U.S. Ser. No. 10/722,150 to L. Likova, the direction of movement of the subject's finger 52 on the screen 53 of the device 51 may be used to code the distance to virtual objects or scene layout features in a miniaturized version of the VEERS concept. As the finger moves, the angle of the most recent segment of the trajectory defines the direction for coding the distance to the first intersection with elements of the virtual scene layout, such as buildings or other objects encoded for any particular application. This distance is then conveyed by an auditory signal of choice, such as the pitch of a tone. The user can then use their finger movements to navigate through the virtual scene layout to practice or test their memory of the scene structure of any virtual layout that is encoded on the screen.

The auditory virtual reality can be further extended with coding of the signals by other modalities such as tactile vibration or verbal instructions.

1. A navigation system for a blind individual that uses non-visual information to guide the individual through a virtual environment, including:
a transponder adapted to be carried by the individual;
a tracking system for determining the position and directional orientation of said transponder within the virtual environment;
a feedback system coupled to said transponder to generate a non-visual sensory signal indicative of said position of said transponder;
said transponder having a primary sensor direction that is aimed by the individual;
said non-visual sensory signal providing indications of virtual objects or walls aligned with said primary sensor direction, whereby the individual may be guided to find or avoid virtual objects or walls in said virtual environment.

2. The navigation system of claim 1, wherein said non-visual sensory signal comprises an audio signal.

3. The navigation system of claim 2, wherein said audio signal includes variable parameters selected from a group including frequency, amplitude, pulse and rhythms.

4. The navigation system of claim 1, wherein said non-visual signal further indicates the relative size and motion of virtual objects relative to the individual in the primary sensor direction.

5. The navigation system of claim 4, wherein said audio signal includes variable parameters selected from a group including frequency, amplitude, pulse and rhythms, said variable parameters having established correspondences with said relative size and motion of the virtual objects.

6. The navigation system of claim 1, wherein said non-visual sensory signal comprises a haptic signal.

7. The navigation system of claim 6, wherein said haptic signal includes variable parameters selected from a group including frequency, amplitude, pulse and rhythms, said variable parameters having established correspondences with physical characteristics of the virtual objects.

8. The navigation system of claim 7, wherein said physical characteristics of the virtual objects include the relative size and motion of virtual objects relative to the individual in the primary sensor direction.

9. The navigation system of claim 8, wherein said non-visual sensory signal includes verbal information.

10. The navigation system of claim 1, wherein said transponder is a smartphone or other self-tracking device that can generate said information about the position and directional orientation of said transponder within the virtual environment.

11. A method for directing an individual to navigate within a virtual environment, including the steps of:
providing a transponder adapted to be carried by the individual, said transponder having a primary sensor direction that is aimed by the individual;
providing a tracking system for determining the position directional orientation of said transponder within the virtual environment;
providing a feedback system coupled to said transponder to generate a non-visual sensory signal indicative of said position of said transponder;
encoding said non-visual sensory signal to provide indications of virtual objects or walls aligned with said primary sensor direction, whereby the individual may be guided to find or avoid virtual objects or walls in said virtual environment.

12. The method of claim 11, wherein said non-visual sensory signal comprises an audio signal, and said audio signal includes variable parameters selected from a group including frequency, amplitude, pulse and rhythms.

13. The method of claim 12, wherein said variable parameters have established correspondences with the size of the virtual objects and their motion with respect to the individual.

14. The navigation system of claim 11, wherein said transponder is a smartphone or other self-tracking device that can generate said information about the position and directional orientation of said transponder within the virtual environment

15. A method for training an individual to create a mental map of a virtual space, including the steps of:
defining a virtual space having one or more virtual objects or walls;
providing the individual with a transponder adapted to be carried by the individual, said transponder having a primary sensor direction that is aimed by the individual;
providing a tracking system for determining the position of said transponder within the virtual environment;
providing a feedback system coupled to said transponder to generate a non-visual sensory signal indicative of said position and directional orientation of said transponder;
encoding said non-visual sensory signal to provide indications of virtual objects or walls aligned with said primary sensor direction, whereby the individual may be guided to find or avoid virtual objects or walls in said virtual environment.
